(19) United States
(12) Patent Application Publication
(10) Pub. No.: US 2006/0273002 A1
(43) Pub. Date: Dec. 7, 2006

(54) Drain filter apparatus

(76) Inventor: Zicel Maymudes, Hawthorne, CA (US)

Correspondence Address: ROY A. EKSTRAND;STE. 150, 3158 REDHILL AVE., COSTA MESA, CA, 92626, US

(21) Appl. No.: 11/144,227

(22) Filed: Jun. 2, 2005

(51) Int. Cl. B01D 25/00

(52) U.S. Cl. 210/460; 210/162; 210/499

(57) ABSTRACT

A drain filter apparatus includes a base portion formed of a flexible resilient plastic or rubber material and defining a center aperture therein. The center aperture supports a mesh filter element having a generally domed shape to facilitate the free flow of drain water through the drain filter apparatus while simultaneously resisting clogging.

### FIELD OF THE INVENTION

This invention relates generally to plumbing apparatus and particularly to filtering devices used in the drain portions thereof.

### BACKGROUND OF THE INVENTION

A variety of well known apparatus such as sinks, tubs, showers and the like employ a water supply and control apparatus such as one or more faucets with water flow control together with one or more discharge or drain apparatus. While the structures of such well known apparatus vary substantially in appearance and significantly in design, all generally include a sink, tub or water collection apparatus together with one or more drain apertures at the lower portions thereof. The drain apertures are typically coupled to a drain or sewer pipe system used to carry away the water flow. One or more faucets coupled to a source of water supply under pressure are operative to control the introduction of water into the plumbing apparatus. The general function of such apparatus is well known in the art and typically includes various sanitation, washing and food preparation processes. In its anticipated use, one or more articles to be washed are placed within the sink or tub environment and the faucets adjusted to provide the desired water flow. Thereafter, the washing process, usually employing a soap or detergent, is carried forward. During the wash and rinse process, the drains are operative to carry away the used washing and rinse water.

In a related and similar art, certain washing facilities are more highly specialized such as those employed to wash and shampoo pets such as dogs or the like. In such case, a typical facility having a larger, often generally flat concave washing and drain area is employed in place of the above-mentioned sink. Various water spray apparatus suitable for application of wash and rinse water to pets replaces the faucets described above. The wash and rinse water is carried away by one or more drains suitably positioned within the washing area.

In a similar apparatus, facilities such as hair salons or hair care stores in general often employ highly specialized sinks which accommodate the positioning of the client's head above the sink while the operator or hair care professional washes or rinses the customer's hair.

Generally speaking, all of the above apparatus are subject to a common problem involving the tendency for collected wash off materials such as food particles and the like in the case of conventional dishwashing and food preparation or similarly accumulated fur or hair in the case of the above-mentioned hair shampooing or pet shampooing activities.

The solution provided here to date by practitioners in the art have primarily comprised a variety of filters situated within the drain path of the apparatus. Often a screen or foraminous element is placed above the drain with the attention and object of allowing water to pass through the filter while debris and wash off material is accumulated at or near the filter and prevented from traveling into the drain system. While the filter devices provided to date typically operate well in initial use, they tend to clog during use and impede water flow. This clogging in turn causes a diminished water flow and backup in the apparatus. Faced with these problems and the need for an effective solution, practitioners in the art have provided a virtually endless variety of devices for filtering the drain systems in plumbing apparatus.

Despite substantial efforts by practitioners in the art, there remains nonetheless a continuing need in the art for an improved filter structure for plumbing system drains.

### SUMMARY OF THE INVENTION

Accordingly, it is a general object of the present invention to provide an improved drain filter apparatus for use in the plumbing arts. It is a more particular object of the present invention to provide an improved drain filter apparatus which is easy to use and which provides sustained use without the problems of filter clogging associated with prior art devices.

In accordance with the present invention, there is provided for use in plumbing apparatus having a water drain, a drain filter comprising: a generally annular flexible resilient base defining a bottom surface, an angled top surface, an outer edge and a center aperture; and a filter element joined to the base to cover the center aperture, the filter element being formed of a mesh material and defining a generally domed upper portion.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a perspective view of a drain filter apparatus constructed in accordance with the present invention and installed in a typical plumbing drain;

FIG. 2 sets forth a section view of the installed drain filter apparatus of FIG. 1 taken along section lines 2-2 therein;

FIG. 3 sets forth a section view of an alternate embodiment of the present invention drain filter apparatus;

FIG. 4 sets forth a section view of a further alternate embodiment of the present invention drain filter apparatus;

FIG. 5 sets forth a section view of a still further alternate embodiment of the present invention drain filter apparatus;

FIG. 6 sets forth a partial section view of a filter element attachment system utilized in the present invention drain filter apparatus;

FIG. 7 sets forth a partial section view of an alternate filter element attachment system for the present invention drain filter apparatus; and

FIG. 8 sets forth a partial section view of a still further alternate filter element attachment system for the present invention drain filter apparatus.

### DESCRIPTION OF THE PREFERRED EMBODIMENTS OF THE INVENTION

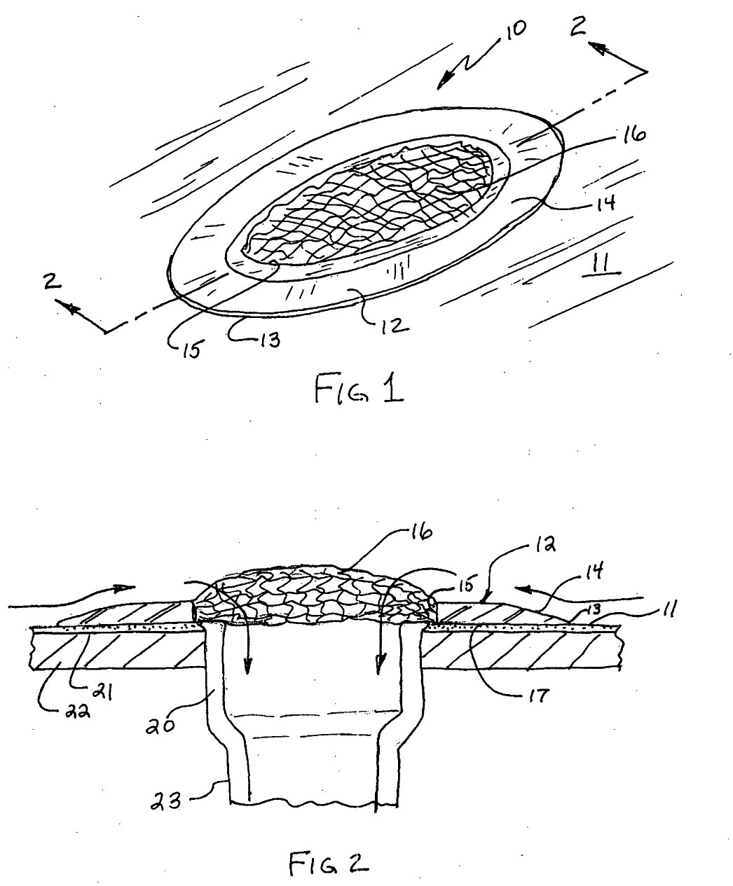

FIG. 1 sets forth a perspective view of a drain filter apparatus constructed in accordance with the present invention and generally referenced by numeral 10. Drain filter apparatus 10 includes a generally annular base 12 having a generally circular outer edge 13 and an upwardly angled surface 14. Base 12 further defines a center aperture 15 which receives and supports a filter element 16. Filter 10 is shown resting upon a typical surface 11 which, as is better seen in FIG. 2, supports a downwardly extending drain 20. In the preferred fabrication of the present invention, annular base 12 is fabricated of a resilient flexible material such as flexible plastic or rubber. In further accordance with the preferred fabrication of the present invention, filter element 16 is formed of a plastic mesh material of the kind utilized in commonly available cleaning pads such as “Scourers” manufactured by Birdwell Cleaning.

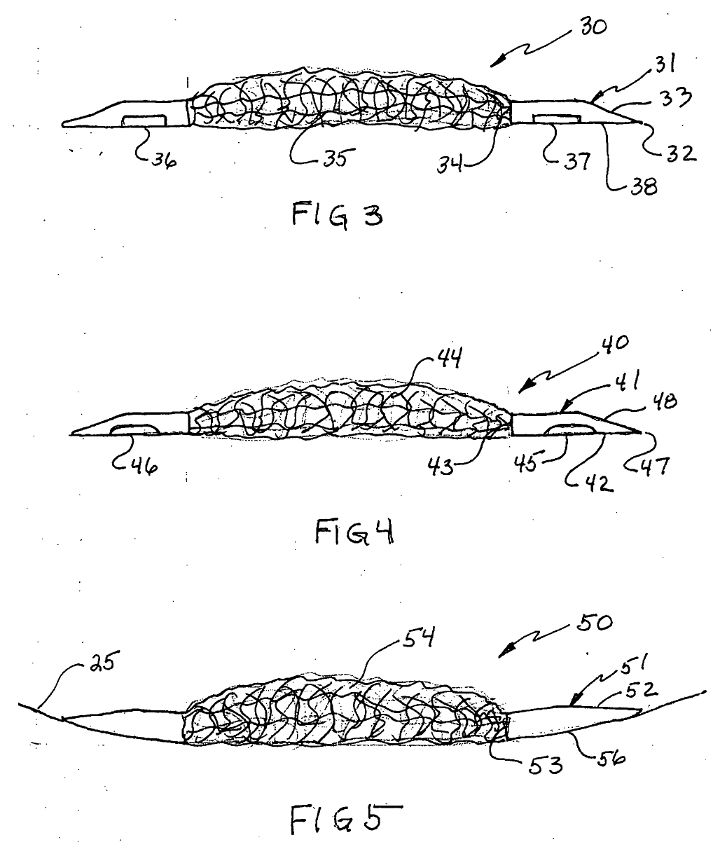

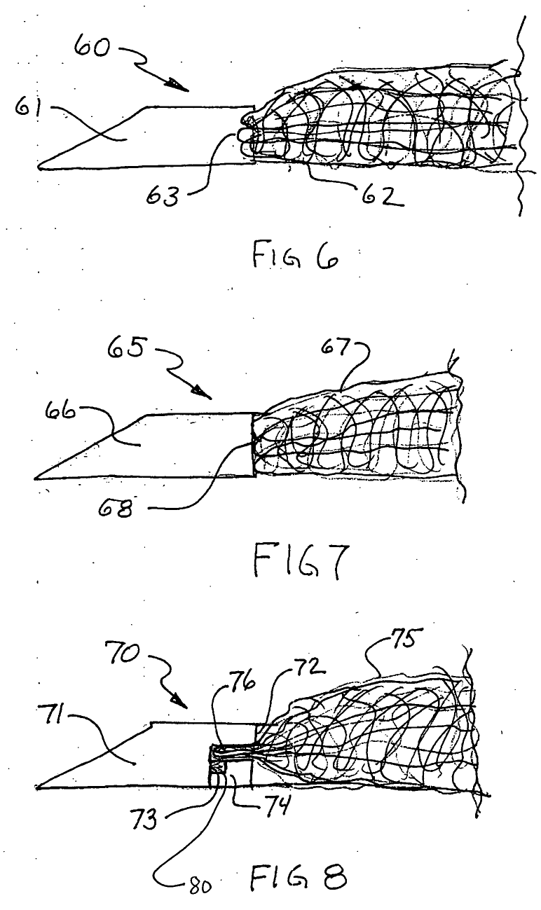

In the typical application of drain filter apparatus 10, annular base 12 is secured to filter element 60 about aperture 15 utilizing any of the conventional attachment systems set forth below with particularity in FIGS. 6, 7 and 8. Suffice it to note here that filter element 16 is secured to annular base 12 at the interior of center aperture 15. In further accordance with the preferred use of the present invention, filter 10 is placed upon surface 11 overlying the drain supported therein such as drain 20 shown in FIG. 2. Angled surface 14 facilitates the positioning of edge 13 against surface 11 to prevent filter 10 from being lifted from surface 11 in the presence of water flow. Thus, as water flows toward drain 20 (seen in FIG. 2), the water flow travels upwardly across angled surface 14 and into filter element 16. Thereafter, the mesh character of filter element 16 allows the water flow to pass downwardly through element 16 and aperture 15 into underlying drain 20. In further accordance with the present invention, the use of filter element 16 in its mesh construction traps debris such as hair or food particles or the like born by the water flow and prevents their travel downwardly into the sink drain. In further accordance with the present invention, the generally domed shape of filter element 16 and its extensive mesh construction allows debris to accumulate about the filter element without clogging the element and thereby allows filter element 16 to continue to flow water despite substantial collection of debris material about the filter element. Edge 13 is maintained in contact with surface 11 under the weight of annular base 12. However, as is set forth below in FIGS. 3 and 4, additional apparatus such as magnets or weights may be embedded within annular base 12 to further secure filter 10 upon surface 11.

Filter apparatus 10 is readily cleaned by simply lifting annular base 12 away from surface 11 and rinsing it and disposing of the contents clogged against filter element 16. In the preferred fabrication of the present invention, filter 10 is fabricated of plastic or rubber materials which resist rusting and which may be used indefinitely.

FIG. 2 sets forth a section view of drain filter apparatus 10 and surface 11 taken along section lines 2-2 in FIG. 1. As described above, drain filter apparatus 10 includes a generally annular base 12 having an outer edge 13 and an angled surface 14. As is also described above, base 12 which is preferably formed of a resilient flexible plastic or rubber material defines a center aperture 15. A mesh filter element 16 is secured to the interior of aperture 15 and supported by annular base 12. A generally flat undersurface 17 is formed upon base 12.

Surface 11 defines the interior surface of a conventional sink or similar plumbing facility having a drain 20 supported thereon. Drain 20 is, in accordance with conventional fabrication, coupled to a drain pipe 23. Drain 20 and pipe 23 cooperate to carry wash or rinse water away from the interior of the sink, tub or other facility within which surface 11 is formed. FIG. 2 also shows a conventional sink formed of a metal portion 22 upon which a protective and decorative layer of porcelain 21 has formed. The importance of observing metal layer 22 beneath porcelain 21 is found in the embodiment set forth below in FIG. 3 in which the base portion of the present invention drain filter apparatus utilizes a plurality of magnets (magnets 36 and 37 seen in FIG. 3) to secure drain filter apparatus to the surface of the host tub, sink or washing facility.

FIG. 3 sets forth a section view of an alternate embodiment of the present invention drain filter apparatus generally referenced by numeral 30. Filter apparatus 30 is fabricated in general accordance with the filter apparatus set forth above in FIGS. 1 and 2 with the further addition of a plurality of magnets such as magnets 36 and 37 embedded within the base portion. The overall function of magnets 36 and 37 is to provide further attachment or security of the placement of filter 30.

More specifically, filter apparatus 30 includes a base 31 preferably formed of a resilient or flexible material such as plastic or rubber or the like. Base 31 defines an outer edge 32, a bottom surface 38 and an angled surface 33. Base 31 defines a center aperture 34 within which a mesh filter element 35 is supported. In accordance with the embodiment of FIG. 3, base 31 further supports a plurality of magnets such as magnets 36 and 37. Magnets 36 and 37 function to provide adherence to the underlying metal surface of the typical sink or tub within which the present invention is utilized. While FIG. 3 in section view shows a pair of magnets 36 and 37, it will be apparent to those skilled in the art that a plurality of further magnets may be utilized in spaced arrangement about base 31 to provide more complete attachment.

FIG. 4 sets forth section view of a still further alternate embodiment of the present invention drain filter apparatus generally referenced by numeral 40. Drain filter apparatus 40 is substantially the same as the above-described drain filter apparatus with the primary difference being found in the use of a plurality of weights such as weights 45 and 46 within the filter base to more securely maintain the position of the filter within the host sink, tub or other facility.

More specifically, drain filter apparatus 40 includes a flexible rubber or plastic base 41 having an undersurface 42, an outer edge 47 and a center aperture 43. A mesh filter element 44 is supported within aperture 43. Base 41 further supports a plurality of weights such as weights 45 and 46 which cooperate with the overall weight of base 41 to maintain the position of filter apparatus 40 upon the surface of the host sink, tub or other washing facility. The flexible base may also, if desired, be made of so-called “magnetic rubber” to attach the metal of the sink drain region magnetically.

FIG. 5 sets forth a section view of a still further alternate embodiment of the present invention drain filter apparatus generally referenced by numeral 50. Drain filter apparatus 50 is shown residing within the concave curved surface 25 of a host sink, tub or other washing facility. Of importance with respect to the present invention is the capability of drain filter apparatus 50 to flex and conform to the curvature of surface 25.

More specifically, filter apparatus 50 includes a base 51 having a center aperture 53 supporting a mesh filter element 54. Base 51 is preferably formed of a flexible and resilient plastic or rubber material and defines an undersurface 56, an outer edge 55 and an angled upper surface 52. In accordance with the present invention, base 51 being formed of a flexible resilient material is able to conform to the curvature of surface 25. Thus, drain filter apparatus 50 may be placed upon a curved surface and readily conformed thereto. This greatly increases the flexibility of use for filter 50.

By way of overview, FIGS. 6, 7 and 8 set forth partial section views of the present invention drain filter apparatus utilizing various methods of attachment between the base portion and the mesh filter elements thereof.

More specifically, FIG. 6 sets forth a partial section view of a portion of a drain filter apparatus 60 having a base 61. A mesh filter element 62 includes an end portion 63 which is molded into the interior of base 61 to provide secure attachment.

FIG. 7 sets forth a partial section view of an alternate method of attachment between the base and mesh filter element portions of the present invention drain filter apparatus. More specifically, a drain filter apparatus 65 includes a generally annular base 66 having a mesh filter element 67 secured within the center aperture thereof by an adhesive bond region 68.

FIG. 8 sets forth a partial section view of a still further alternate method of attachment between the base and mesh filter elements of the present invention drain filter apparatus. More specifically, a drain filter apparatus 70 includes a base 71 defining a generally annular recess 73. A suitably sized and formed annular snap ring 74 is tightly fitted within recess 73 and due to the resilience of base 70 is received in a pressed fit attachment. A mesh filter element 75 defines an outer portion 76 and portion 80 which are captivated within recess 73 by snap ring 74.

An important advantage of the method of attachment shown in FIG. 8 is found in the readily interchangeable character of mesh filter elements 75. A simple removal of snap ring 74 facilitates the removal of mesh filter element 75 and the reattachment thereof or the attachment of a new replacement mesh filter.

What has been shown is a drain filter apparatus which employs a generally dome-shaped filter element formed of a plastic mesh material. The mesh material and its domed shape provides substantial resistance to clogging while simultaneously allowing free flow of drain water therethrough. The entire apparatus is formed of relatively low cost, easy to manufacture elements.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. For use in plumbing apparatus having a water drain, a drain filter comprising:
a generally annular flexible resilient base defining a bottom surface, an angled top surface, an outer edge and a center aperture; and
a filter element joined to said base to cover said center aperture, said filter element being formed of a mesh material and defining a generally domed upper portion.
